(19) United States
(12) Patent Application Publication
(10) Pub. No.: US 2007/0159352 A1
(43) Pub. Date: Jul. 12, 2007

(54) Bearing assembly having built-in wireless sensor

(76) Inventors: Koji Sahashi, Shizuoka (JP); Koichi Okada, Shizuoka (JP); Masatoshi Mizutani, Shizuoka (JP)

Correspondence Address: STAAS & HALSEY LLP, SUITE 700, 1201 NEW YORK AVENUE, N.W., WASHINGTON, DC, 20005, US

(21) Appl. No.: 10/573,487

(22) PCT Filed: Sep. 22, 2004
(86) PCT No.: PCT/JP04/13787

§ 371 Date: Mar. 24, 2006

(30) Foreign Application Priority Data
Sep. 26, 2003 (JP) 2003-335685

(51) Int. Cl. H04Q 9/00

(52) U.S. Cl. 340/870.07

(57) ABSTRACT

A wireless sensor incorporated bearing assembly includes a bearing (1) including a stationary race member (3) and a rotatable race member (2), a sensor unit (9) and a sensor unit mounting device (30) for removably mounting the sensor unit (9) on the stationary race member (3) of the bearing (1). The sensor unit (9) is of one-piece construction including a sensor section (26) for detecting a target of detection, a signal transmitting circuit (29b) and a transmitting antenna (29a). The sensor unit (9) includes, as an electric power supply section (27), a section that does not require wiring, for example, an electric power receiving section (28) for receiving an electric power by wireless, or a battery or electric power generator.

### FIELD OF THE INVENTION

The present invention relates to a bearing assembly having a wireless sensor built therein, which is applied in bearing assemblies used for various machines and equipments and automotive wheels and which is capable of detecting the number of revolutions or any other target of detection and then transmitting a sensor output by wireless.

### BACKGROUND ART

Bearings used in, for example, industrial machines, testing equipments and cars, are often provided with a sensor to render the bearing to be intelligent so that sensor signals can be used in, for example, controlling machines and equipments and controlling the status of the bearing. The sensor signals are generally transmitted by means of a wiring system, but it is often experienced that a proper place for wiring is hardly available in the bearings. In view of this, the bearing assembly having the wireless sensor incorporated therein has been suggested, in which a detection signal is transmitted utilizing electromagnetic waves.

Also, the wireless ABS (Anti-Brake System) sensor has been suggested, in which a signal from a revolution sensor mounted on the wheel support bearing assembly can be transmitted by wireless, eliminating the harness extending between a vehicle wheel and a vehicle body structure. See, for example, the Japanese Laid-open Patent Publication No. 2002-264786. For the revolution sensor, a rotary type electric power self-generator having a multipolar magnet is used as a revolution sensor and an electric power for driving the sensor and a transmitting device is obtained by a self-generation. By so doing, the necessity of a wiring system for supplying an electric power from the vehicle body structure to the revolution sensor is eliminated. The use of the wireless system is particularly advantageous in that the weight can be reduced, the assemblability can be improved, and troubles due to breakage of harnesses brought about by collision with stones and so on can be avoided.

In the wheel support bearing assembly, the wireless supply of an electric power to the revolution sensor has been also suggested. See, for example, the Japanese Laid-open Patent Publication No. 2003-146196. Unlike the self-generation system, this wireless supply system of the electric power enables the revolution sensor to detect the number of revolutions and transmit the sensor signal even during the halt of wheel revolution and the low speed wheel revolution.

The wireless sensor incorporated bearing assembly is advantageous in the elimination of the wiring and easy assemblability, compared with the wired sensor incorporated bearing assembly. In view of this, the inventors of the present invention have tried to effectively utilize those advantages.

In the wireless sensor incorporated bearing assembly, mounting of the sensor unit onto the bearing assembly is carried out by fixing. Such fixing often poses a problem brought about by the fixing of the sensor unit particularly during maintenance of the bearing assembly. By way of example, when a grease is supplemented in the bearing assembly or the bearing assembly is dismantled for cleaning, a required work cannot be performed easily if the sensor unit is fixed in position. Also, while in testing machines, it often occur that a particular sensor of one kind is desired to be replaced with another sensor of a different kind, but this replacement cannot be accomplished with no difficulty.

On the other hand, the wired sensor incorporated bearing assembly has been suggested, in which the sensor is removably mounted on the bearing. See, for example, the Japanese Laid-open Patent Publication No. 6-308145. According to this bearing assembly, mounting and removing of the sensor can easily be accomplished. However, since the sensor has a wiring connected thereto, it often occurs that the sensor cannot be easily removed or mounted as the wiring interferes.

### DISCLOSURE OF THE INVENTION

An object of the present invention is to provide a wireless sensor incorporated bearing assembly, in which mounting and removing of a sensor relative to a bearing can be easily accomplished without being disturbed by wiring.

A wireless sensor incorporated bearing assembly of the present invention includes a bearing having a stationary race member and a rotatable race member, a sensor unit and a wireless sensor unit mounting device for removably mounting the wireless sensor unit on the stationary race member of the bearing. The wireless sensor unit is of one-piece construction including a sensor section for detecting a target of detection, a signal transmitting circuit for transmitting a sensor signal outputted from the sensor section, and a transmitting antenna.

According to this construction, since the sensor signal can be transmitted by wireless, no wiring for the sensor signal is required. Also, since the wireless sensor unit can be removably mounted on the bearing through the sensor unit mounting device, the wireless sensor unit can easily be removed from the bearing. In such case, since no wiring for the sensor signal is employed, the wiring does in no way constitute an obstacle and a work to remove the sensor unit can be facilitated. In this way, by the synergistic effect of the sensor unit mounting device, enabling the removable mounting of the sensor unit, and the wireless system, easy mounting and removal of the sensor unit can be carried out at any time. Because of this, maintenance of the bearing can be easily performed with the sensor unit removed and, also, replacement of the sensor unit with a different sensor unit can easily be performed so that a different target of detection can be detected. By way of example, where different targets of detection are desired to be detected with testing equipments, a plurality of sensor units each for detecting a particular target of detection are prepared and replaced in turn to obtain a wide variety of detection results.

In the present invention, the sensor unit may preferably include an electric power supply section for driving the sensor section and the signal transmitting circuit, which section does not require the use of a wiring between the sensor unit and the outside of the sensor unit. By way of example, the electric power supply section may include an electric power receiving section for receiving the electric power by wireless, or include a battery or an electric power generator.

Where the sensor unit includes, as the electric power supply section, the electric power receiving section, the battery or the electric power generator, no electric power supply wiring leading to the sensor unit is also required and the sensor unit can be completely tailored to have a wireless feature. The synergistic effect of the removable sensor unit mounting device and the wireless-featured sensor unit brings about a large effect of achieving the easy mounting and removing of the sensor unit.

In particular, where the sensor unit includes the electric power receiving section for receiving the electric power by wireless, no maintenance such as replacement of the battery is required and reduction in the weight of the bearing can be obtained and, yet, unlike the rotary type electric power generator, the sensor unit can obtain electric power at any time for operation.

Where the electric power supply section is an electric power generator, no replacement of the battery is required and no electric power transmitting section for the wireless supply of the electric power is also required, resulting in the simplification of the structure. The electric power generator may be, other than the rotary type electric power generator, a photoelectric converting element such as a solar cell for converting light into electricity, or a thermoelectric converting element such as a Peltier element for converting heat into electricity.

It is to be noted that where any means other than the battery is employed as the electric power supply section, the use of a capacitor or a secondary battery is preferred to stabilize the supply of the electric power.

In the present invention, the sensor section may include a revolution sensor, which is comprised of a pulsar ring for generating a cyclic magnetic change in a circumferential direction thereof and a magnetic sensor arranged in face-to-face relation to the pulsar ring. The sensor unit includes the magnetic sensor while the pulsar ring is fitted to the rotatable race member.

Where the bearing is equipped with a sensor for detecting the number of revolutions, the utility of such bearing is high. With the pulsar ring and the magnetic sensor referred to above, a highly precise detection of revolutions can be accomplished.

In the present invention, the sensor unit mounting device may include a fixing ring mounted on the stationary race member, a socket portion provided in the fixing ring for allowing the sensor unit to be removably inserted in a radial direction of the bearing, and a retaining portion provided in the fixing ring or the socket portion for elastically retaining the sensor unit inserted into the socket portion.

Since the sensor unit mounting device includes the socket portion and the elastic retaining portion, removing and mounting of the sensor unit can be easily carried out and the positioning of the sensor unit during the mounting can easily be performed. Since this socket portion is fitted to the stationary race member through the fixing ring, fitting of the socket portion to the stationary ring member can also be performed easily.

The wireless sensor incorporated bearing assembly of the present invention may be a rolling bearing including rows of rolling elements interposed between respective raceway surfaces defined in the stationary and rotatable race members. The rolling bearing may be either a double row type or a single row type and the rolling elements employed therein may be a ball, roller or tapered roller. The bearing may also be a plain bearing. Also, the bearing may be a radial type bearing or a thrust type bearing.

The rolling bearing referred to above may be a wheel support bearing assembly, which is used for rotatably supporting a vehicle wheel relative to a vehicle body structure and which includes an outer member having a plurality of raceway surfaces and defining the stationary race member, an inner member having raceway surfaces confronting with the raceway surfaces in the outer member and defining the rotatable race member, and a plurality of rows of rolling elements interposed between the mutually confronting raceway surfaces in the outer and inner members.

Where the present invention is applied to the wheel support bearing assembly, the effect that the removing and mounting of the sensor unit relative to the bearing can easily be accomplished without being disturbed by wiring can bring about a high practical utility during the maintenance.

Thus, since the wireless sensor incorporated bearing assembly of the present invention includes the bearing including the stationary race member and the rotatable race member, the sensor unit and the sensor unit mounting device for removably mounting the sensor unit on the stationary race member of the bearing and since the sensor unit is of one-piece construction including the sensor section for detecting a target of detection, the signal transmitting circuit for transmitting a sensor signal outputted from the sensor section, and the transmitting antenna, removing and mounting of the sensor unit relative to the bearing can be easily and simply accomplished because of the synergistic effect of the capability of the sensor unit being removably mounted by the sensor unit mounting device and the wireless feature of the sensor unit requiring no wiring. Accordingly, not only can the maintenance be performed easily, but the type of sensor can easily be changed.

In particular, where the sensor unit includes, as the electric power supply section for driving the sensor section and the signal transmitting circuit, a section that requires no wiring with outside of the sensor unit, for example, the electric power receiving section for receiving the electric power by wireless, or the battery or electric power generator, no wiring for the electric power supply system is required and no interference during removing and mounting of the sensor unit will occur by wiring. Accordingly, the synergistic effect of the capability of the sensor unit being removably mounted and the easiness to perform the removing and mounting of the sensor unit without being disturbed by wiring is high.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is an explanatory diagram showing a sectional view of a wireless sensor incorporated bearing assembly according to a first preferred embodiment of the present invention and a block diagram showing a conceptual structure of a sensor unit used therein;

FIG. 2 is a sectional view of the wireless sensor incorporated bearing assembly according to a second preferred embodiment of the present invention:

FIG. 3 is a sectional view of the wireless sensor incorporated bearing assembly, in which the present invention is applied to a wheel support bearing assembly;

FIG. 4 is a rear view of the bearing assembly of FIG. 3 as viewed from an inboard side;

FIG. 5 is a sectional view showing, on an enlarged scale, a portion indicated by A in FIG. 3;

FIG. 6 is a perspective view showing, on an enlarged scale, an important portion of a sensor unit mounting device in the bearing assembly of FIG. 3;

FIG. 7A is a side view of the sensor unit in the bearing assembly of FIG. 3;

FIG. 7B is a rear view of the sensor unit; and

FIG. 8 is a schematic diagram showing the relation between a pulsar ring and a magnetic sensor;

### BEST MODE FOR CARRYING OUT THE INVENTION

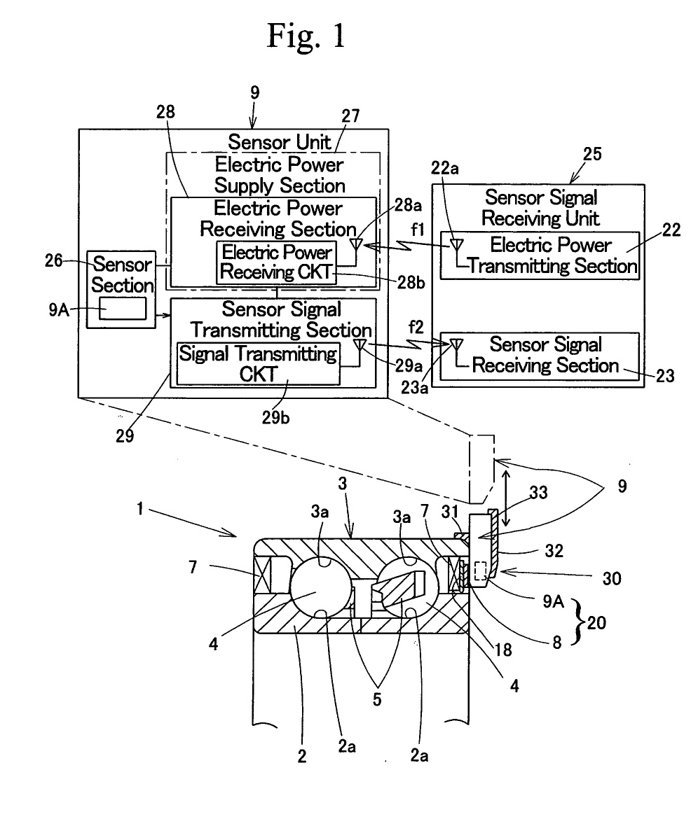

A first preferred embodiment of the present invention will be described in detail with reference to FIG. 1. The wireless sensor incorporated bearing assembly of the present invention includes a bearing 1, a sensor unit 9 and a sensor unit mounting device 30 for removably mounting the sensor unit 9 on a stationary race member 3 of the bearing 1. The bearing 1 includes the stationary race member 3 and a rotatable race member 2 and may be in the form of either a rolling bearing or a plain bearing, but is shown in the illustrated embodiment as a rolling bearing including rows of rolling elements 4 interposed between raceway surfaces 3a and 2a defined respectively in the stationary race member 3 and the rotatable race member 2. In this embodiment, the stationary race member 3 is an outer race and the rotatable race member 2 is an inner race. Also, this rolling bearing I is in the form of a double row angular contact ball bearing. Each of the rows of the rolling elements 4 is retained by a respective retainer 5.

The sensor unit 9 includes a sensor section 26 for detecting a target of detection, a sensor signal transmitting section 29 for transmitting a sensor signal outputted from the sensor section 26, and an electric power supply section 27, all of which are integrated together. The integration may be accomplished by enclosing the sensor section 26, the sensor signal transmitting section 29 and the electric power supply section 27 in a casing, for example, a resin casing or by mounting the sensor section 26, the sensor signal transmitting section 29 and the electric power supply section 27 on a substrate, which is in turn resin molded.

The sensor signal transmitting section 29 includes an antenna 29a and a signal transmitting circuit 29b. The electric power supply section 27 includes an electric power receiving section 28 for receiving an electric power by wireless. The electric power receiving section 28 includes an antenna 28a and an electric power receiving circuit 28b. An electric power supply circuit of the electric power supply section 27 may be provided with a capacitor or a secondary battery (both not shown) for accumulating an electric power received by the electric power receiving section 28.

The sensor unit 9 and a sensor signal receiving unit 25 positioned separate and distant from the sensor unit 9 altogether form a wireless sensor system. The sensor signal receiving unit 25 includes a sensor signal receiving section 23 for receiving the sensor signal transmitted from the sensor signal transmitting section 29 of the sensor unit 9, and an electric power transmitting section 22 for transmitting an electric power by wireless to the electric power receiving section 28. The sensor signal receiving section 23 includes an antenna 23a and a receiving circuit and, on the other hand, the electric power transmitting section 22 includes an antenna 22a and a transmitting circuit.

The sensor unit 9 and the sensor signal receiving unit 25 may be in one-to-one relation to each other. Alternatively, reception of the sensor signal and transmission of the electric power may be carried out between the single sensor signal receiving unit 25 and the plural sensor units 9 one for each bearing 1. If the frequency of transmission of the sensor signal is changed or the time division communication is carried out for the sensor signals, the respective sensor signals from the plural sensor units 9 can be identified in the sensor signal receiving unit 25. Transmission of the electric power may be carried out using the same frequency for the plural sensor units 9.

Transmission and reception between the sensor signal transmitting section 29 and the sensor signal receiving section 23 and between the electric power transmitting section 22 and the electric power receiving section 28 may be carried out by electromagnetic waves, light waves, infrared beams, ultrasonic waves or magnetic coupling. Where the electromagnetic waves are employed therefor, the respective frequencies of transmission of the sensor signal and the electric power, both transmitted by wireless, are preferably different from each other. In the illustrated embodiment, the frequency of the electric power is denoted by f1 and the frequency of the sensor signal is denoted by f2.

The sensor section 26 includes a magnetic sensor 9A forming a part of a revolution sensor device 20. This revolution sensor device 20 is made up of a pulsar ring 8 and the magnetic sensor 9A disposed in face-to-face relation therewith. Opposite ends of the bearing 1 is provided with sealing members 7 to seal a space between the rotatable race member 2 and the stationary race member 3. The pulsar ring 8 is mounted externally on the rotatable race member 2 through a core metal 18 of the sealing member 7 positioned at one end of the bearing 1. The pulsar ring 8 is, as shown in FIG. 8, in the form of a magnet magnetized to have a plurality of alternating magnetic poles N and S in a circumferential direction of the pulsar ring 8, or in the form of a magnetic ring having gear-like serrations defined therein, and has a cyclic change in the circumferential direction thereof. The combination of the pulsar ring 8, in the form of the multipolar magnet, and the magnetic sensor 9A can obtain a compact and precise revolution sensor. The magnet forming the pulsar ring 8 may be a rubber magnet, a plastic magnet, or a sintered magnet.

The magnetic sensor 9A can be employed in the form of a magnetoresistive sensor (generally referred to as “MR sensor”), or an active magnetic sensor such as a Hall element sensor, a flux gate type magnetic sensor and an MI sensor. Of them, the magnetoresistive sensor can be advantageously employed for the wireless supply of the electric power since if the resistance is increased, the electric power consumption can be minimized.

The sensor unit mounting device 30 includes a fixing ring 31 fixedly mounted on the stationary race member 3, a socket portion 32 provided in the fixing ring 31 and used to removably mount the sensor unit 9 in the radial direction of the bearing 1, and a retaining portion 33 for elastically retaining the sensor unit 9 mounted in the socket portion 32. This sensor unit mounting device 30 may be made of, for example, metallic plate material or synthetic resin in its entirety or may be made of both of metallic plate material and synthetic resin.

The socket portion 32 allows the sensor unit 9 to be inserted therein a predetermined depth, when the sensor unit 9 is inserted from outside in the radial direction of the bearing 1, to thereby position the sensor unit 9 in the predetermined depth. The retaining portion 33 serves to retain the sensor unit 9 at the predetermined depth. This retaining portion 33 includes an engagement piece that is provided in the socket portion 32 and is engageable with an outer end face of the sensor unit 9 in the radial direction of the bearing 1 or with a stepped face (not shown) provided in the sensor unit 9. The retaining portion 33 may be projected from the fixing ring 31, instead of being projected from the socket portion 32. The fixing ring 31 is mounted on an outer periphery or an inner periphery of the stationary race member 3. This fixing ring 31 may be provided with a portion that is engageable in a circumferential groove or recess defined in the outer periphery or inner periphery of the stationary race member 3 to position the fixing ring 31 axially on the stationary race member 3.

It is to be noted that the sensor section 26 of the sensor unit 9 may include, in addition to the magnetic sensor 9A, a sensor (not shown) for detecting a target of detection other than the number of revolutions such as temperature, vibration, acceleration, preload on the bearing, load or torque. In such case, respective sensor signals from those sensors can be transmitted as superimposed or on a time division basis from the same sensor signal transmitting section 29.

According to the wireless sensor incorporated bearing assembly of the structure described above, the sensor signal indicative of, for example, the number of revolutions detected by the sensor section 26 is transmitted from the sensor signal transmitting section 29 and, on the other hand, the electric power receiving section 28 receives the electric power to drive the sensor section 26 and the sensor signal transmitting section 29. Accordingly, it is possible to eliminate wiring for sensor signal and electric power between the bearing 1 and the sensor signal receiving section 25 and to achieve reduction in the weight of the bearing assembly, improvement in the assemblability of the bearing assembly, avoidance of troubles resulting from wiring breakage due to collision with stones and so on. Because of the wireless transmission of the electric power, unlike the self-generation system of electric power, the senor section 26 can detect the number of revolutions even during the halt of wheel revolution and the low speed wheel revolution.

Also, since the sensor unit 9 is removably mounted on the bearing 1 through the sensor unit mounting device 30, the sensor unit 9 can be easily removed from the bearing 1. In such case, since no wiring is employed for the sensor signal and also for the electric power supply, the removing of the sensor unit 9 can be easily accomplished. Thus, by the synergistic effect of the sensor unit mounting device 30, enabling the removable mounting of the sensor unit 9, and the wireless system, easy mounting and removing of the sensor unit 9 can be achieved. Because of this, maintenance of the bearing 1 can be performed with the sensor unit 9 removed and, also, replacement of the sensor unit 9 with a different sensor unit can easily be performed so that a different target of detection can be detected. By way of example, where different targets of detection are desired to be detected with testing equipments, a plurality of sensor units each for detecting a particular target of detection are prepared and replaced in turn to obtain a wide variety of detection results.

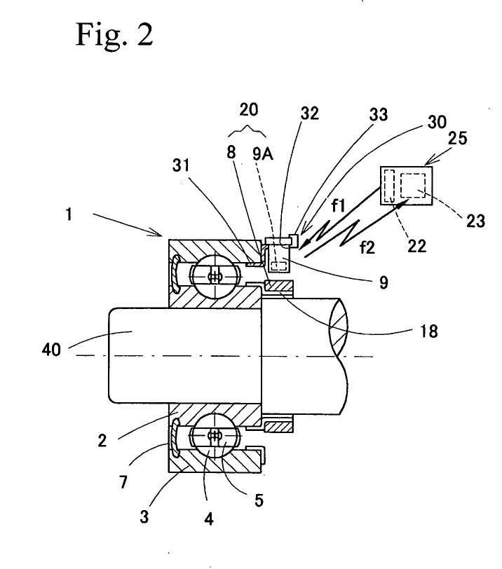

FIG. 2 illustrates a second preferred embodiment of the present invention. In this second embodiment, reference numerals identical to those employed in the first embodiment in FIG. 1 are equally employed to denote like parts. This second embodiment is directed to the bearing 1 which is a single row rolling bearing. A shaft 40 is inserted in and hence supported by the rotatable race member 2 serving as an inner race. The revolution sensor 20 is of a radial type, in which the pulsar ring 8 and the magnetic sensor 9A are held in face-to-face relation in the radial direction of the bearing 1. The revolution sensor 20 is arranged outside the bearing 1 and juxtaposes the bearing 1 in an axial direction of the bearing 1. The pulsar ring 8 is mounted on the outer periphery of the rotatable race member 2 serving as an inner race. The magnetic sensor 9A is provided in the sensor unit 9, which is mounted on the stationary race member 3 through the sensor unit mounting device 30.

The sensor unit mounting device 30 includes a fixing ring 31 fixedly mounted on the inner periphery of the stationary race member 3, a socket portion 32 provided in the fixing ring 31 and used to removably mount the sensor unit 9 in the radial direction of the bearing 1, and a retaining portion 33 for elastically retaining the sensor unit 9 mounted in the socket portion 32. The socket portion 32 is in the form of an engagement hole defined in the fixing ring 31. The sensor unit 9 has an insertable portion, that can be inserted into the engagement hole, and a non-insertable portion that cannot be inserted into the engagement hole. The non-insertable portion is engaged with an outer peripheral surface of the fixing ring 31, positioning the sensor unit 9 in the radial direction of the bearing 1. The retaining portion 33 is in the form of a tongue that is turned backwardly from the fixing ring 31 so as to protrude in the axial direction of the bearing 1. The sensor unit mounting device 30 may be made of, for example, metallic plate material or synthetic resin in its entirety. Alternatively, the sensor unit mounting device 30 may be made of both of the metallic plate material and the synthetic resin. It is to be noted that in this second embodiment, the core metal 18 does not form the sealing member, but may be designed to form the sealing member as in the first embodiment.

Other structural features of the second embodiment than those described above are similar to those shown in and described in connection with the first embodiment with reference to FIG. 1. Even in this second embodiment, function and effects similar to those afforded by the first embodiment can be obtained.

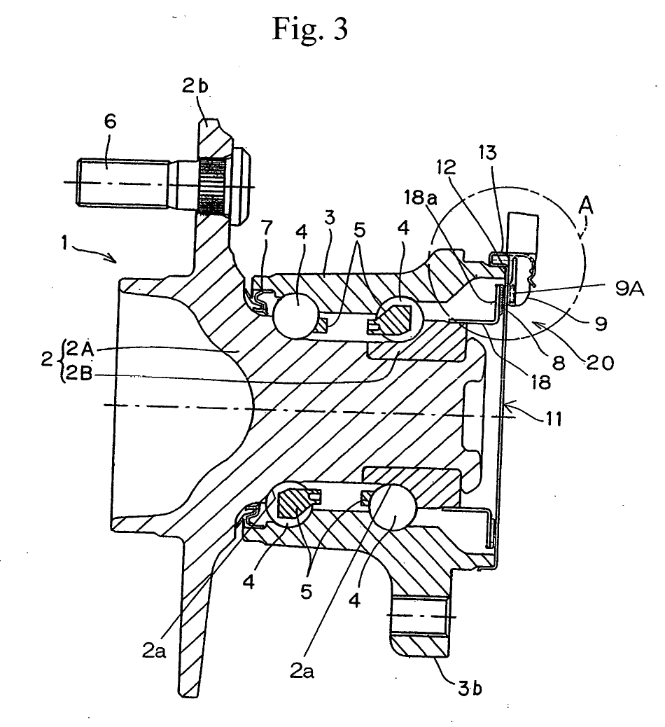

FIGS. 3 to 8 illustrate a third preferred embodiment of the present invention. In this third embodiment, reference numerals identical to those employed in the first embodiment in FIG. 1 are equally employed to denote like parts. This third embodiment is applied to a wheel support bearing assembly for supporting a vehicle driven wheel. Referring first to FIG. 3, the bearing 1 includes a rotatable race member 2, which is an inner member, and a stationary race member 3 which is an outer member, the inner and outer members 2 and 3 being rotatable relative to each other through rolling elements 4. The rolling elements 4 are provided in double rows and each row of the rolling elements 4 is retained by a respective retainer 5. The stationary race member 3 has an outer periphery formed with a vehicle body fitting flange 3a through which it is secured to a knuckle (not shown) or the like the vehicle body structure. The rotatable race member 2 has an outboard end formed with a wheel mounting flange 2b to which the vehicle wheel (not shown) is secured through a plurality of bolts 6. This rotatable race member 2 is made up of a hub axle 2A and an inner race segment 2B mounted externally on an inboard end of the hub axle 2A, with the raceway surfaces 2a defined in the hub axle 2A and the inner race segment 2B, respectively. An outboard end of the annular bearing space delimited between the rotatable race member 2 and the stationary race member 3 is sealed by the sealing member 7.

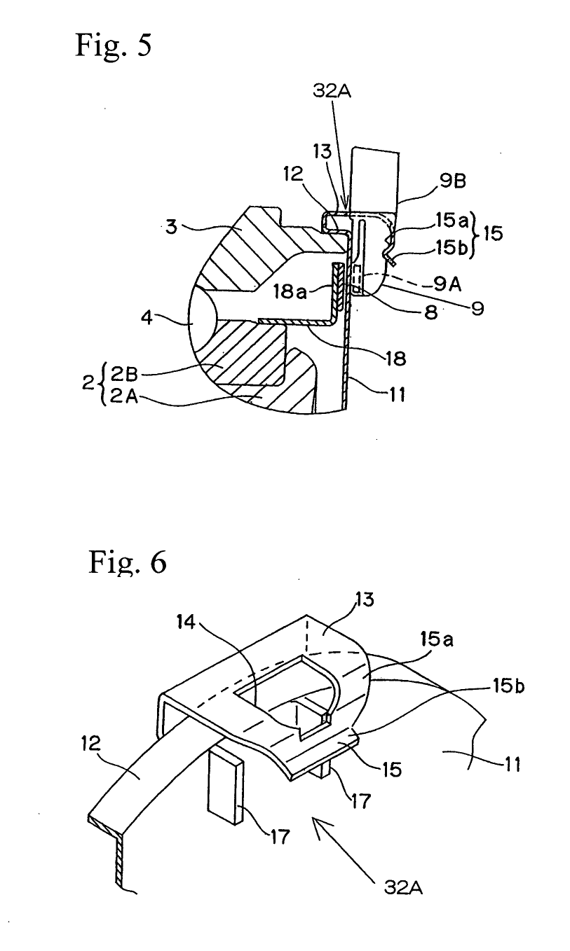

As shown in FIG. 5 showing on an enlarged scale a portion of FIG. 3 indicated by A, the pulsar ring 8 forming a to-be-detected member used in detecting the number of revolutions of the vehicle wheel is arranged in an inboard end of the annular bearing space delimited between the rotatable and stationary race members 2 and 3. The magnetic sensor 9A for detecting a magnetic change of the pulsar ring 8 is provided as the sensor unit 9 in non-contact and face-to-face relation to the pulsar ring 8. The pulsar ring 8 is fitted to the rotatable race member 2 serving as the inner member. The sensor unit 9 is fitted to the stationary race member 3, serving as the outer member, through a sensor unit mounting device 11. The pulsar ring 8 and the magnetic sensor 9A in the sensor unit 9 altogether form the revolution sensor 20.

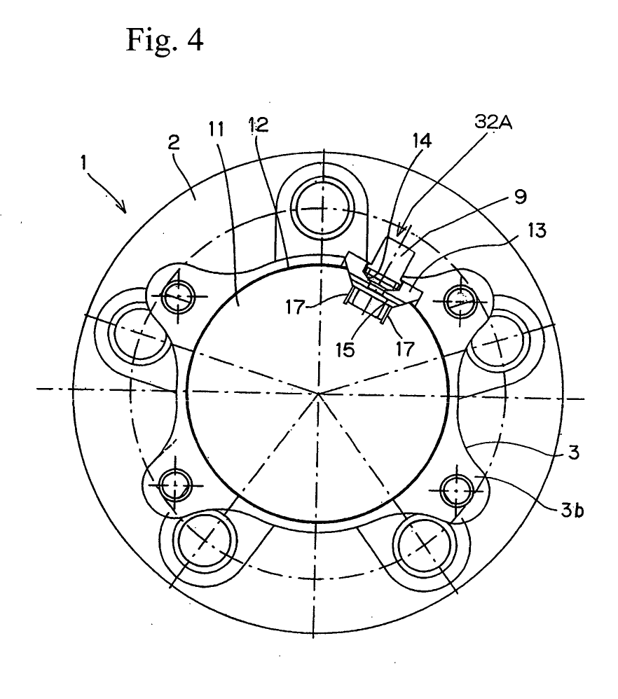

The sensor unit mounting device 11 is made of a non-magnetic material and is of a shape similar to a cap covering an end face of the stationary race member 3. The sensor unit mounting device 11 includes a collar-shaped fixing ring 12 defined in an outer peripheral edge thereof and a socket portion 32A. This sensor unit mounting device 11 is fixedly mounted on an outer peripheral surface of the inboard end of the stationary race member 3 through the fixing ring 12. Accordingly, the inboard end of the annular bearing space delimited between the rotatable and stationary race members 2 and 3 is sealed (See FIG. 3.). The sensor unit mounting device 11 is in the form of a substantially flat disc having its outer peripheral edge formed with the fixing ring 12. Although in the illustrated embodiment, the sensor unit mounting device 11 is made of a metallic plate material, it may be made of a synthetic resin. Where the sensor unit mounting device 11 is made of a synthetic resin, it may have a core metal embedded therein. On the other hand, where the sensor unit mounting device 11 is made of a metallic plate material, austenite stainless steel, for example, SUS304 according to the JIS standard can be employed as a non-magnetic metallic plate. FIG. 4 illustrates a rear view of the bearing 1, which is the wheel support bearing assembly shown in FIG. 3, as viewed from inboard side. As shown in FIG. 4, the socket portion 32A is defined at one location in the circumferential direction of the sensor unit mounting device 11, but may be defined at a plurality of locations in the circumferential direction. In such case, a plurality of sensors of different kinds can be mounted on the bearing 1 to render the bearing 1 to be highly intelligent. Alternatively, the sensors of the same type can be mounted on the bearing 1.

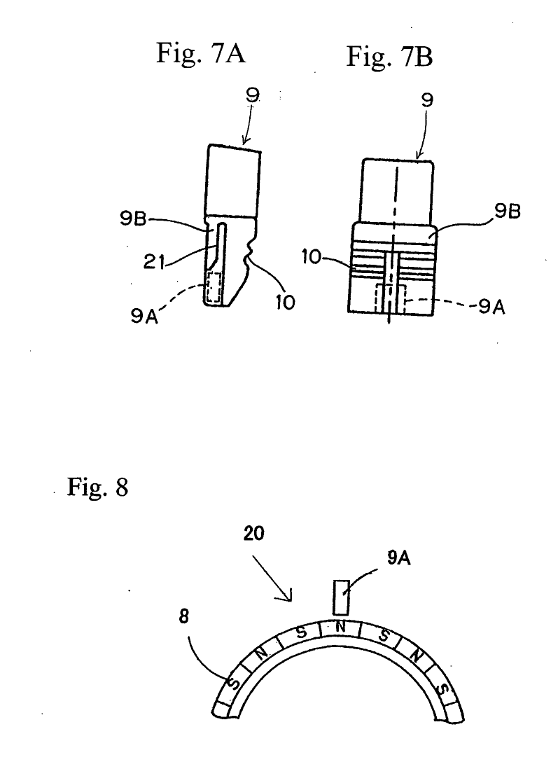

As shown in a perspective view in FIG. 6, the sensor unit mounting device 11 is also integrally formed with a sensor support projection 13 that protrudes radially outwardly from a free end of the fixing ring 12 and is then bent to extend towards the inboard side in the axial direction of the bearing 1. The sensor support projection 13 has an engagement hole 14 defined therein for enabling the sensor unit 9 to be removably inserted in the radial direction of the bearing 1 and a retaining portion 15 for positioning the senor unit 9 in the axial and radial directions of the bearing 1. The retaining portion 15 includes a curved portion 15a in the form of a projecting piece and an engagement bent portion 15b. The curved portion 15a extends further away from a free end of the sensor support projection 13 and is curved to extend towards an inner end in the radially inward direction of the bearing 1. The engagement bent portion 15b is bent from a free end of the curved portion 15a to represent a generally L-shaped section and engageable in an engagement recess 10 (See FIGS. 7A and 7B.) defined in a rear lower half of the sensor unit 9. Also, a pair of regulating projecting walls 17 is formed on the sensor unit mounting device 11 at a location closer to the center portion of the flat disc shaped mounting device 11 in the radially inward direction of the bearing 1 than the engagement hole 14 is. The pair of regulating projecting walls 17 protrudes from the sensor unit mounting device 11 towards the inboard side to receive the sensor unit 9 from lateral sides and to regulate the displacement in position of the sensor unit 9 in the circumferential direction of the bearing 1. Those regulating projecting walls 17 and the sensor support projection 13 altogether constitute the socket portion 32A.

The sensor unit mounting device 11 is of one-piece construction including the sensor support projection 13 and the retaining portion 15 and is made of a metallic plate by press work. The regulating projecting walls 17 may be either formed integrally with the sensor unit mounting device 11 or rigidly secured to the sensor unit mounting device 11. It is to be noted that the sensor support projection 13 and the retaining portion 15 may be separate from, but rigidly secured to the sensor unit mounting device 11.

The pulsar ring 8 is in the form of a ring-shaped member having a plurality of alternating magnetic poles S and N deployed in the circumferential direction and may be employed in the form of a multipolar magnet, for example, a rubber magnet, a plastic magnet or a sintered magnet. This pulsar ring 8 is integrally formed with an annular core metal 18 and is mounted on the outer periphery of the rotatable race member 2 through the core metal 18. The core metal 18 is so shaped as to represent a generally L-sectioned configuration having a radial upright wall 18a and the pulsar ring 8 is fixedly secured to one of opposite surfaces of the radial upright wall 18a that is oriented towards the inboard side.

The sensor unit 9 is of a structure in which, as shown in side and rear elevational views of FIGS. 7A and 7B, respectively, the magnetic sensor 9A for detecting the pulsar ring 8 is enclosed within a sensor encasing body 9B together with the sensor signal transmitting section 29 and the electric power supply section 28 both shown in FIG. 1. The magnetic sensor 9A is positioned within the sensor encasing body 9B at the lower half thereof. The sensor encasing body 9B may be in the form of either a casing made of a resin material or a resin molded body with the magnetic sensor 9A embedded therein.

A rear surface of the sensor unit 9, that is, a surface of the sensor unit 9 opposite to the surface thereof confronting with the pulsar ring 8, is provided with the engagement recess 10 for engagement with the retaining portion 15. This engagement recess 10 is in the form of a grooved recess extending over the entire width of the sensor unit 9 in a widthwise direction of the sensor unit 9 (that is, in a circumferential direction of the race member). Other structural features of the third embodiment than those described above are similar to those shown in and described in connection with the first embodiment with reference to FIG. 1.

According to the wireless sensor incorporated bearing assembly of the structure described above, since one open end of the stationary race member 3 is covered by the sensor unit mounting device 11 with the sensor unit 9 supported outside thereof, there is no need to use any sealing member, for example, an O-ring for sealing the interior of the bearing assembly at a location where the sensor unit 9 is mounted. In other words, where the sensor unit of, for example, a cylindrical configuration is fitted to a cover member through a throughhole defined in the cover member, the use of the sealing member such as an O-ring is required in the throughhole, but in the third embodiment of FIG. 5, no sealing member of that kind is required. Also, since the sensor support projection 13 provided in the sensor unit mounting device 11 is provided with the engagement hole 14 and the retaining portion 15, the sensor unit 9 can be easily and removably mounted on the bearing assembly. The sensor unit 9 inserted into the engagement hole 14 is kept in position by the pair of the regulating projecting walls 17 without displacing in the circumferential direction and any displacement in the radial and axial directions can be restrained by a push exerted by the retaining portion 15. When the engagement bent portion 15b of the retaining portion 15 is engaged in the engagement recess 10 in the sensor unit 9, constrains the sensor unit 9 is prevented from displacing in the radial direction to thereby retain the sensor unit 9 in position. Also, since the inboard opening of the stationary race member 3 is closed by the sensor unit mounting device 11, it is possible to avoid ingress of foreign matter and/or muddy water into the bearing assembly and also to eliminate the use of the sealing member which has hitherto been required at the one end of the annular bearing space delimited between the rotatable and stationary race members. The elimination of the sealing member is effective to reduce the rotational resistance in the bearing assembly, eventually resulting in increase of the mileage of an engine. The sensor unit mounting device 11 concurrently serves as means for sealing the bearing space and also for fitting the support projection 13 and the retaining portion 15 to the stationary race member 3 and, accordingly, the number of component parts used can be reduced, allowing the structure to be simplified. Also, since the sensor support projection 13 is in the form of a bent piece and the retaining portion 15 is in the form of a projecting piece extending further from the bent piece, the sensor unit mounting device 11 can be formed integrally with the sensor support projection 13 and the retaining portion 15 using the metallic plate by press work, thereby facilitating the manufacture of the sensor unit mounting device. For this reason, a low manufacturing cost can be accomplished.

Since, while the sensor unit 9 is arranged in face-to-face relation with the pulsar ring 8 with the disc of the sensor unit mounting device 11 interposed therebetween, the sensor unit mounting device 11 is made of the non-magnetic material, there is no possibility that detection of the pulsar ring 8 by the sensor unit 9 is interfered with the sensor unit mounting device 11. If the sensor unit mounting device 11 has a large plate thickness, an air gap between the sensor unit 9 and the pulsar ring 8 increases, accompanied by reduction in detecting precision, and accordingly the plate thickness of the sensor unit mounting device 11 is preferred to be as small as possible and, more specifically, equal to or smaller than 1 mm.

Also, in the wheel support bearing assembly, where the sensor unit 9 including the electric power receiving section 28 is employed, it is possible to eliminate any harness between the vehicle wheel and the vehicle body structure and to achieve reduction in weight, improvement in assemblability, avoidance of troubles resulting from harness breakage brought about by collision with stones and so on. Because of the wireless transmission of the electric power, the sensor section 26 can perform revolution detection even during the halt of wheel revolution and the low speed wheel revolution, unlike the sensor in the self-generation system.

Although this embodiment has been shown and described as applied to the wheel support bearing assembly for the support of the vehicle driven wheel, the present invention can be equally applied to the wheel support bearing assembly for the support of a vehicle drive wheel.

It is to be noted that although in describing any one of the foregoing embodiments, the electric power supply section 27 of the sensor unit 9 has been shown and described as having the wireless electric power receiving section 28, the electric power supply section 27 may be a battery or an electric power generator. The electric power generator may be, other than a rotary type electric power generator, a photoelectric converting element such as a solar cell for converting light into electricity, or a thermoelectric converting element such as a Peltier element for converting heat into electricity. Also, the electric power supply section 27 may obtain an electric power from outside through a wiring system.

What is claimed is:

1. A wireless sensor incorporated bearing assembly comprising:
a bearing including a stationary race member and a rotatable race member;
a wireless sensor unit; and
a sensor unit mounting device for removably mounting the sensor unit on the stationary race member of the bearing;
the sensor unit being of one-piece construction including a sensor section for detecting a target of detection, a signal transmitting circuit for transmitting by wireless a sensor signal outputted from the sensor section, and a transmitting antenna.

2. The wireless sensor incorporated bearing assembly as claimed in claim 1, wherein the sensor unit includes, as an electric power supply section for driving the sensor section and the signal transmitting circuit, an electric power receiving section for receiving an electric power by wireless.

3. The wireless sensor incorporated bearing assembly as claimed in claim 1, wherein the sensor unit includes as an electric power supply section for driving the sensor section and the signal transmitting circuit, a battery or an electric power generator.

4. The wireless sensor incorporated bearing assembly as claimed in claim 1, wherein the sensor section includes a revolution sensor, the revolution sensor including a pulsar ring for generating a cyclic magnetic change in a circumferential direction of the pulsar ring and a magnetic sensor fitted in face-to-face relation to the pulsar ring; and
wherein the sensor unit includes the magnetic sensor while the pulsar ring is fitted to the rotatable race member.

5. The wireless sensor incorporated bearing assembly as claimed in claim 1, wherein the sensor unit mounting device includes a fixing ring mounted on the stationary race member, a socket portion provided in the fixing ring for allowing the sensor unit to be removably inserted in a radial direction of the bearing, and a retaining portion provided in the fixing ring or the socket portion for elastically retaining the sensor unit inserted into the socket portion.

6. The wireless sensor incorporated bearing assembly as claimed in claim 1, wherein the bearing is a rolling bearing including a plurality of rows of rolling elements interposed between the stationary and rotatable race members.

7. The wireless sensor incorporated bearing assembly as claimed in claim 6, wherein the rolling bearing is a wheel support bearing assembly used for rotatably supporting a vehicle wheel relative to a vehicle body structure, the wheel support bearing assembly comprising an outer member having a plurality of raceway surfaces and defining the stationary race member, an inner member having raceway surfaces confronting with the raceway surfaces in the outer member and defining the rotatable race member, and a plurality of rows of rolling elements interposed between the mutually confronting raceway surfaces in the outer and inner members.
